(19) United States
(12) Patent Application Publication
(10) Pub. No.: US 2026/0355982 A1
(43) Pub. Date: Nov. 12, 2026

(54) AGILE HANDS AND HUMANOID ROBOTS

(71) Applicant: HUMANOID ROBOT (SHANGHAI) CO., LTD., Shanghai (CN)

(72) Inventors: Lei Jiang, Shanghai (CN); Yongyao Li, Shanghai (CN); Yufei Liu, Shanghai (CN)

(21) Appl. No.: 19/220,000

(22) Filed: May 27, 2025

Related U.S. Application Data
(63) Continuation of application No. PCT/CN2025/097006, filed on May 23, 2025.

(30) Foreign Application Priority Data
May 9, 2025 (CN) 202510593435.X

(51) Int. Cl. B25J 15/00

(52) U.S. Cl. CPC B25J 15/0009

(57) ABSTRACT

The present disclosure provides a dexterous hand and humanoid robot, where the dexterous hand includes a palm structure and a gripping finger structure, where the gripping finger structure includes a joint assembly, a first driving assembly, a swinging assembly, a fixing bracket, and an auxiliary assembly. The fixing bracket is connected to the palm structure. The swinging assembly is rotatably connected to the palm structure and is elastically connected to the fixing bracket, the joint assembly is rotatably connected to the swinging assembly, and a rotation axis of the swinging assembly is perpendicular to a rotation axis of the joint assembly. Along an expansion and contraction direction of the auxiliary assembly, one end of the auxiliary assembly is connected to the joint assembly through a universal structure, and the other end of the auxiliary assembly is connected to the first drive assembly through the universal structure.

### CROSS-REFERENCE TO RELATED APPLICATIONS

This application is a continuation of International Application No. PCT/CN2025/097006, filed on May 23, 2025, which claims priority to Chinese Patent Application No. 202510593435.X, filed with the China National Intellectual Property Administration on May 9, 2025 and entitled “DEXTEROUS HAND AND HUMANOID ROBOT”, both of which are hereby incorporated by reference in their entireties.

### TECHNICAL FIELD

The present disclosure relates to the technical field of robots, and in particular, to a dexterous hand and a humanoid robot.

### BACKGROUND

A dexterous hand of a robot is a precise and complex structure, and is also a critical terminal execution device in the modern robotic technology, and its design objective is to try to be as anthropomorphic as possible in the shape and function. Therefore, the structure of the dexterous hand includes a palm and fingers, where a driving structure and a transmission structure are provided inside the palm, and the driving structure drives the fingers to move through the transmission structure, so as to enable the dexterous hand to hold an object.

However, when the driving structure and the transmission structure of the dexterous hand in the current market are cooperated with each other, the problem of poor self-adaptability of the dexterous hand is easily caused, which makes the dexterous hand stiffer and less flexible.

### SUMMARY

The present disclosure provides a dexterous hand and a humanoid robot, so as to solve the problem of poor self-adaptability of the dexterous hand.

The present disclosure provides a dexterous hand, including a palm structure and a gripping finger structure, where the gripping finger structure includes a joint assembly, a first driving assembly, a swinging assembly, a fixing bracket and an auxiliary assembly, and the fixing bracket is connected to the palm structure; the swinging assembly is rotatably connected to the palm structure, the swinging assembly is elastically connected to the fixing bracket, the joint assembly is rotatably connected to the swinging assembly, and a rotation axis of the swinging assembly is perpendicular to a rotation axis of the joint assembly; the auxiliary assembly is configured to be elastically stretchable, and along an expansion and contraction direction of the auxiliary assembly, one end of the auxiliary assembly is connected to the joint assembly through a universal structure, the other end of the auxiliary assembly is connected to the first driving assembly through the universal structure, the first driving assembly is connected to the fixing bracket, and the first driving assembly is adapted to drive the joint assembly to rotate relative to the swinging assembly by driving the auxiliary assembly to move.

The dexterous hand provided in the present disclosure is provided with the swinging assembly, the joint assembly is rotatably connected to the swinging assembly, and the swinging assembly is rotatably connected to the palm structure, so that the joint assembly can rotate relative to the swinging assembly so as to make the joint assembly bend relative to the palm structure, thereby enabling the joint assembly to cooperate with the palm structure to grip an object; and the joint assembly also can swing relative to the palm structure along with the swinging assembly so as to enable the joint assembly to have a lateral swinging movement in addition to a bending movement, thereby increasing the flexibility of the joint assembly. Furthermore, the swinging assembly is elastically connected to the fixing bracket, such a connecting manner generates a restoring force between the swinging assembly and the fixing bracket when the swinging assembly rotates relative to the palm structure under the action of an external force, and the restoring force makes the swinging assembly have a tendency to rotate along an opposite direction relative to the palm structure to restore to its original position. When the external force is removed, the restoring force forces the swinging assembly to rotate reversely to restore to its original position, thereby restoring the joint assembly to its original position. In this way, the flexible self-adaptability of the joint assembly can be improved, thereby making the joint assembly move flexibly and restore its original position self-adaptively.

In addition, the auxiliary assembly is further provided in the present disclosure. The auxiliary assembly can transmit a driving force of the first driving assembly, so that the joint assembly can rotate relative to the swinging assembly, so as to enable the joint assembly to bend relative to the palm structure, thereby achieving the cooperation between the joint assembly and the palm structure to grip the object. Furthermore, the auxiliary assembly in the present disclosure is not only configured to transmit the driving force, but also is configured to be elastically stretchable. In a case where the first driving assembly loses power, an output end of the first driving assembly remains stationary, and at this moment, when an external force is applied to the joint assembly and the joint assembly is forced to rotate relative to the swinging assembly, the auxiliary assembly is compressed under the action of the external force; and when the auxiliary assembly is compressed, the joint assembly can rotate relative to the swinging assembly. In this way, even if the first driving assembly loses power, the joint assembly may still bend relative to the palm structure, ensuring the flexibility of the joint assembly. Moreover, when the auxiliary assembly is compressed, the auxiliary assembly has an elastic force for restoring its original shape, so as to force the auxiliary assembly to have a tendency to restore to its original shape. If the external force is removed from the joint assembly, the auxiliary assembly can restore to its original shape through the elastic force at this moment; and during the process of the auxiliary assembly restoring to its original state, the joint assembly is driven to rotate relative to the swinging assembly to restore its original position at the same time, thereby increasing the self-adaptive function of the joint assembly.

In one possible implementation, the auxiliary assembly includes a sleeve and a pin rod, where the pin rod is slidably connected to the sleeve, a first elastic member is connected between the sleeve and the pin rod, one end of the sleeve away from the pin rod is connected with a first connecting part, one end of the pin rod away from the sleeve is connected with a second connecting part, and the first connecting part and the second connecting part are each a universal structure.

In one possible implementation, the first connecting part includes a first ball head and a connecting rod, where the connecting rod is provided to protrude from the first ball head, the connecting rod is adapted to be rotatably connected to the joint assembly, a first connecting hole is provided at one end of the sleeve away from the pin rod, and the first ball head is connected to the first connecting hole; and the second connecting part includes a second ball head and a connecting shaft, where a second connecting hole is provided at one end of the pin rod away from the sleeve, the second ball head is connected to the second connecting hole, the connecting shaft is connected to the second ball head, and the connecting shaft is adapted to be rotatably connected to the first driving assembly.

In one possible implementation, the sleeve includes an inserting channel, and the pin rod is inserted into the inserting channel.

In one possible implementation, an outer wall of the sleeve is further provided with a limiting groove, the limiting groove is provided along a sliding direction of the pin rod relative to the sleeve, a limiting pin is further connected to the pin rod, and the limiting pin is inserted into the limiting groove.

In one possible implementation, along a direction perpendicular to the rotation axis of the swinging assembly, one end of the swinging assembly is provided with a first connecting part, and the other end of the swinging assembly is provided with a second connecting part, where the first connecting part is rotatably connected to the joint assembly, and the second connecting part is elastically connected to the fixing bracket.

In one possible implementation, the swinging assembly further includes at least one second elastic member, where two ends of the second elastic member are respectively connected to the second connecting part and the fixing bracket, and the second elastic member is adapted to provide for the second connecting part an elastic force to resist rotation of a swinging body.

In one possible implementation, the first driving assembly includes a first driving member, a first driving screw rod and a first sliding member, where the first driving member is connected to the fixing bracket, and the first driving screw rod is connected to an output end of the first driving member; the first sliding member has a threaded hole, the first sliding member is threadedly connected to the first driving screw rod through the threaded hole, the first sliding member is movably connected to the fixing bracket, and one end of the auxiliary assembly is connected to the first sliding member.

In one possible implementation, the fixing bracket includes a bracket body, where the first driving member is fixed to the bracket body, the bracket body is provided with a plurality of guiding members, each guiding member extends along an extension direction of the first driving screw rod, and the each guiding member is provided to penetrate through the first sliding member.

In one possible implementation, the bracket body is provided with an accommodating groove, the bracket body is further provided with a first through-hole and a second through-hole that are spaced apart, the first through-hole and the second through-hole are both in communication with the accommodating groove, the first driving screw rod is provided to penetrate through the first through-hole, the accommodating groove and the second through-hole in sequence, and the first sliding member is located in the accommodating groove.

In one possible implementation, an adaptor is further provided inside the second through-hole and a portion of the first driving screw rod located in the second through-hole is rotatably connected to the bracket body through the adaptor.

In one possible implementation, the joint assembly includes a first joint, a second joint and a third joint which are arranged in sequence, where two ends of the second joint are respectively rotatably connected to the first joint and the third joint, and the first joint is rotatably connected to the swinging assembly.

In one possible implementation, a first connecting rod is further provided inside the first joint, where one end of the first connecting rod is rotatably connected to the swinging assembly, and the other end of the first connecting rod is rotatably connected to the second joint.

In one possible implementation, a third elastic member is provided inside the second joint, where one end of the third elastic member is connected to the first joint, and the other end of the third elastic member is connected to the third joint.

In one possible implementation, a rotation axis of the second joint and the third joint is further connected to a torsion spring, where two ends of the torsion spring are respectively abutted against the second joint and the third joint, and the torsion spring is adapted to resist an elastic force of the third elastic member.

In one possible implementation, the dexterous hand further includes a thumb structure, where the thumb structure includes a mounting seat, a first knuckle and a second knuckle, two ends of the first knuckle are respectively rotatably connected to the mounting seat and the second knuckle, and the mounting seat is connected to the palm structure.

In one possible implementation, the thumb structure includes a second driving assembly and a rotating member, where the first knuckle is connected to the rotating member, the rotating member is rotatably connected to the mounting seat, and the second driving assembly is adapted to drive the rotating member to rotate relative to the mounting seat.

In one possible implementation, the thumb structure further includes a fixing assembly, the fixing assembly being rotatably connected to the mounting seat; and the second driving assembly includes a second driving member, a second driving screw rod and a second sliding member, where the second driving member is connected to the fixing assembly, the second driving screw rod is connected to an output end of the second driving member, the second sliding member is threadedly connected to the second driving screw rod, the second sliding member is provided with a plurality of connecting rods, the mounting seat is provided with a sliding groove, the rotating member is provided with a rotating through-hole, at least one of the connecting rods is inserted into each of the sliding groove and the rotating through-hole.

In one possible implementation, the thumb structure further includes a second connecting rod and a third driving assembly, where one end of the second connecting rod is rotatably connected to the second knuckle, and the other end of the second connecting rod is rotatably connected to the rotating member; the first knuckle is rotatably connected to the rotating member; the third driving assembly is rotatably connected to the first knuckle; and a partial structure of the third driving assembly is in transmission connection with the second connecting rod, so as to drive the first knuckle and the second knuckle to rotate through the second connecting rod.

In one possible implementation, the third driving assembly includes a third driving member, a third driving screw rod and a third sliding member, where the third driving screw rod is connected to a protruding end of the third driving member, the third sliding member is threadedly connected to the third driving screw rod, an end of the second connecting rod is rotatably connected to the third sliding member, and a position where the second connecting rod is connected to the third sliding member is rotatably connected to the second knuckle.

The present disclosure further provides a humanoid robot, including a robot body and the dexterous hand described above.

### BRIEF DESCRIPTION OF THE DRAWINGS

To illustrate the technical solutions in the embodiments of the present disclosure or in the prior art more clearly, a brief introduction will be given to the accompanying drawings required for the description of the embodiments or prior art. It is obvious that the accompanying drawings described below are merely some embodiments of the present disclosure, and for those skilled in the art, other drawings can be obtained according to these drawings without creative efforts.

FIG. 1 is a structural schematic diagram of a dexterous hand provided by an embodiment of the present disclosure.

FIG. 2 is an exploded view of a palm structure provided by an embodiment of the present disclosure.

FIG. 3 is a structural schematic diagram of a gripping finger structure provided by an embodiment of the present disclosure.

FIG. 4 is an exploded view of a gripping finger structure provided by an embodiment of the present disclosure.

FIG. 5 is an exploded view of an auxiliary assembly provided by an embodiment of the present disclosure.

FIG. 6 is a partial structural exploded view of a gripping finger structure provided by an embodiment of the present disclosure.

FIG. 7 is an exploded view of a dexterous hand provided by an embodiment of the present disclosure.

FIG. 8 is a structural schematic diagram of a connecting structure formed by an auxiliary structure and a first sliding member provided by an embodiment of the present disclosure.

FIG. 9 is an exploded view of a fixing bracket provided by an embodiment of the present disclosure.

FIG. 10 is a sectional view of a gripping finger structure provided by an embodiment of the present disclosure.

FIG. 11 is a sectional view of another gripping finger structure provided by an embodiment of the present disclosure.

FIG. 12 is a sectional view of yet another gripping finger structure provided by an embodiment of the present disclosure.

FIG. 13 is an exploded view of another dexterous hand provided by an embodiment of the present disclosure.

FIG. 14 is an exploded view of a thumb structure provided by an embodiment of the present disclosure.

FIG. 15 is an exploded view of a mounting structure formed by a second driving assembly and a mounting seat provided by an embodiment of the present disclosure.

FIG. 16 is an exploded view of another thumb structure provided by an embodiment of the present disclosure.

FIG. 17 is a partial schematic structural diagram of a dexterous hand provided by an embodiment of the present disclosure.

### REFERENCE NUMERALS

10—palm structure; 11—palm center; 111—fixing member; 112—mounting port; 12—palm back; 13—fixing base; 131—fixing countersunk hole; 14—flexible pad; 15—control assembly; 151—control board; 152—communication interface;
20—gripping finger structure; 21—joint assembly; 211—first joint; 2111—first connecting boss; 212—second joint; 2121—second connecting boss; 213—third joint; 2131—third connecting boss; 214—first connecting rod; 215—third elastic member; 216—torsion spring; 22—first driving assembly; 221—first driving member; 222—first driving screw rod; 223—first sliding member; 2231—threaded hole; 23—fixing bracket; 231—bracket body; 2311—accommodating groove; 2312—first through-hole; 2313—second through-hole; 2314—first mounting hole; 232—guiding member; 233—adaptor; 24—swinging assembly; 241—swinging bearing; 242—fixing screw; 243—swinging body; 2431—first connecting part; 2432—second connecting part; 24321—second mounting hole; 244—second elastic member; 25—auxiliary assembly; 251—first connecting assembly; 2511—first ball head; 2512—connecting rod; 252—sleeve; 2521—first connecting hole; 2522—inserting channel; 2523—limiting groove; 253—first elastic member; 254—pin rod; 2541—second connecting hole; 255—limiting pin; 256—second connecting assembly; 2561—second ball head; 25611—inserting hole; 2562—connecting shaft;
30—thumb structure; 31—mounting seat; 311—first seat body; 3111—sliding groove; 312—second seat body; 32—second driving assembly; 321—second driving member; 322—second driving screw rod; 323—second sliding member; 3231—connecting protruding block; 33—fixing assembly; 331—first fixing member; 332—second fixing member; 3321—connecting protrusion; 3322—groove; 333—fixing bearing; 334—clamping member; 34—rotating member; 341—rotating through-hole; 342—first rotating hole; 343—second rotating hole; 344—rotating shaft; 35—first knuckle; 36—second knuckle; 37—second connecting rod; 38—third driving assembly; 381—third driving member; 382—third driving screw rod; 383—third sliding member.

### DESCRIPTION OF EMBODIMENTS

The technical solutions in the embodiments of the present disclosure will be clearly and completely described below in conjunction with the accompanying drawings in the embodiments of the present disclosure. Obviously, the described embodiments are merely part rather than all of the embodiments of the present disclosure. Based on the embodiments disclosed in the present disclosure, all other embodiments obtained by those ordinary skilled in the art without creative efforts shall belong to the protection scope of the present disclosure.

According to the background art, it can be seen that there is a problem of poor self-adaptability in the existing dexterous hand; and the reason for this problem is that a transmission structure of the dexterous hand in the current market is mainly divided into a tendon rope, a connecting rod, a gear, a worm gear, etc., and the driving structure is directly connected to the finger through the transmission structure. When the driving structure operates, the movement can be transmitted to the finger through the transmission structure, causing the finger to bend, but when the driving structure does not work, that is, in a standing state, since the transmission structure and the dexterous hand are directly connected and the transmission structure is in transmission connection with the driving structure, the driving structure becomes the only driving way for driving the finger to bend. At this moment, when an external force is applied to the finger, a locking structure is formed between the transmission structure and the driving structure, which prevents the finger from bending, so that the finger cannot bend self-adaptively when the driving structure does not work, thereby causing the finger to be not flexible.

Based on this, the present disclosure provides a dexterous hand. The dexterous hand in the present disclosure is provided with an auxiliary assembly, and a driving structure is connected to a joint assembly through the auxiliary assembly. The auxiliary assembly can not only transmit a driving force of the driving structure so as to enable the driving structure to lead the joint assembly to bend, but also give place to the bending of the joint assembly when the driving structure does not work, so that the joint assembly can self-adaptively bend, no longer relying solely on the driving structure to drive bending.

The technical solutions of the present disclosure and how to solve the above technical problems will be described in detail below with reference to specific embodiments. The following specific embodiments may be combined with each other, and the same or similar concepts or procedures may not be repeated in certain embodiments. The embodiments of the present disclosure will be described below in conjunction with the accompanying drawings.

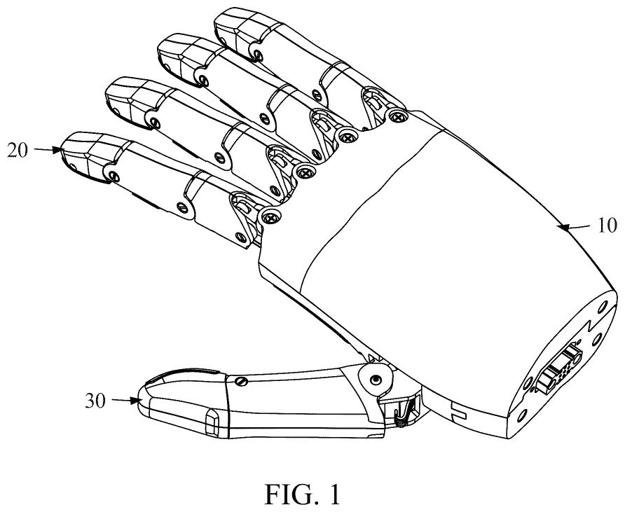

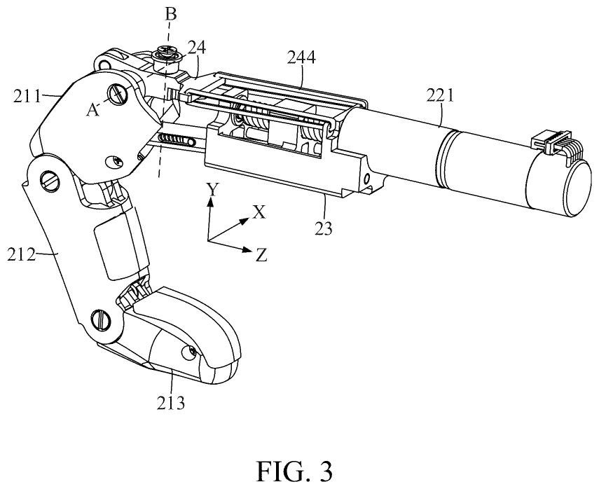

In an aspect, an embodiment of the present disclosure provides a dexterous hand that can be applied to a humanoid robot, and the dexterous hand is configured to simulate a human hand for holding an object. Referring to FIGS. 1-4, in some possible implementations, the dexterous hand in the present disclosure includes a palm structure 10 and a gripping finger structure 20, where the gripping finger structure 20 is connected to the palm structure 10 for the dexterous hand to hold an object. It can be understood that the gripping finger structure 20 is a finger structure that is designed for the dexterous hand to simulate the human hand, and the gripping finger structure 20 of the present disclosure specifically includes an index finger, a middle finger, a ring finger and a little finger that are provided to simulate the human hand. In the present disclosure, the index finger, the middle finger, the ring finger and the little finger of the dexterous hand have similar main structures, and can achieve identical functions and degree of freedom, therefore, the gripping finger structure 20 in the present disclosure is configured to replace any one of anthropomorphic finger structures from the index finger, the middle finger, the ring finger and the little finger. It should be noted that the gripping finger structure 20 is different from a thumb structure 30 mentioned later, because the thumb structure 30 only has two knuckles and the thumb structure 30 is greatly different from the structure of the remaining four fingers. Therefore, the present disclosure will describe the thumb structure 30 and the remaining four fingers separately.

The gripping finger structure 20 in the present disclosure includes a joint assembly 21, a first driving assembly 22, a swinging assembly 24, a fixing bracket 23 and an auxiliary assembly 25, where the fixing bracket 23 is connected to the palm structure 10. The joint assembly 21 refers to joints provided to simulate the human fingers, where various joints are connected with each other and can move. The joint assembly 21, the first driving assembly 22, the swinging assembly 24, the fixing bracket 23 and the auxiliary assembly 25 are cooperatively connected with each other to form a finger module of anthropomorphic finger, while the fixing bracket 23 may be connected to the palm structure 10 so as to connect the entire finger module to the palm structure 10.

Specifically, the palm structure 10 includes a palm center 11 and a palm back 12, where the palm center 11 and the palm back 12 are provided separately, and the palm center 11 and the palm back 12 are detachably connected. For example, the palm center 11 and the palm back 12 may be connected together through a clamping structure, a fastening structure, or a screw. In the present disclosure, the palm center 11 and the palm back 12 are connected with each other through the screw. In addition, a flexible pad 14 is further provided on an end surface of the palm center 11 facing away from the palm back 12, the flexible pad 14 may be made of a silicone or rubber material, and the flexible pad 14 may be connected to the palm center 11 by means of adhesive bonding. By providing the flexible pad 14, not only can the object avoid direct contact with the palm center 11, which is beneficial for the palm center 11 not being worn out, but also the flexible pad 14 can increase a friction coefficient of the palm center 11, so that the object is not easy to slip off when being gripped by the dexterous hand.

In the present disclosure, an accommodating space is enclosed between the palm center 11 and the palm back 12, and the fixing bracket 23 may be located in the accommodating space and connected to the palm center 11 by the screw, thereby connecting the gripping finger structure 20 to the palm structure 10. When the gripping finger structure 20 is connected to the palm structure 10, the joint assembly 21 of the gripping finger structure 20 is exposed outside the palm structure 10, so that the joint assembly 21 bends to cooperate with the palm structure 10 to achieve a gripping action.

The swinging assembly 24 is rotatably connected to the palm structure 10, and the swinging assembly 24 is elastically connected to the fixing bracket 23. The joint assembly 21 is rotatably connected with the swinging assembly 24, so that when the swinging assembly 24 rotates relative to the palm structure 10, the joint assembly 21 may rotate relative to the palm structure 10 along with the swinging assembly 24. Furthermore, the joint assembly 21 may also rotate relative to the swinging assembly 24, and thus the movement of joint assembly 21 relative to palm structure 10 at least includes the rotation with the swinging assembly 24 and the rotation of joint assembly 21 itself.

It should be noted that, a rotation axis of the swinging assembly 24 rotating relative to the palm structure 10 and a rotation axis of the joint assembly 21 rotating relative to the swinging assembly 24 are provided to be perpendicular to each other. In the present disclosure, the rotation of the joint assembly 21 relative to the swinging assembly 24 is recorded as a bending movement of the joint assembly 21, and can also be regarded as a gripping movement in which the joint assembly 21 bends relative to the palm structure 10. When the joint assembly 21 rotates relative to the swinging assembly 24, it can cooperate with the palm structure 10 to grip the object. In the present disclosure, the rotation of the swinging assembly 24 relative to the palm structure 10 is recorded as the swinging of the joint assembly 21, that is, when the joint assembly 21 rotates along with the swinging assembly 24, the joint assembly 21 swings leftward and rightward relative to the palm structure 10, so as to simulate the leftward and rightward swinging of the human finger. It should be noted here that, the leftward and rightward swinging of the joint assembly 21 for simulating the index finger and the little finger of the human hand means that the joint assembly 21 moves towards or away from the adjacent joint assembly 21 around the rotation axis of the swinging assembly 24 rotating relative to the palm structure 10. With regard to the joint assembly 21 simulating the middle finger and ring finger of the human hand, there are two adjacent joint assemblies 21 in a swing direction, for example, the index finger and the ring finger are adjacent to the middle finger, and the middle finger and the little finger are adjacent to the ring finger, therefore, the leftward and rightward swinging of the joint assembly 21 for simulating the middle finger and ring finger of the human hand means that the joint assembly 21 moves towards one adjacent joint assembly 21 and moves away from the other adjacent joint assembly 21 around the rotation axis of the swinging assembly 24 rotating relative to the palm structure 10.

The auxiliary assembly 25 is configured to be elastically stretchable, and along an expansion and contraction direction of the auxiliary assembly 25, one end of the auxiliary assembly 25 is connected to the joint assembly 21 through a universal structure, and the other end of the auxiliary assembly 25 is connected to an output end of the first driving assembly 22 through a universal structure. In the present disclosure, the first driving assembly 22 is connected to the fixing bracket 23, so that the first driving assembly 22 can drive the auxiliary assembly 25 to move. Since the joint assembly 21 is simultaneously connected to the swinging assembly 24 and the auxiliary assembly 25, the joint assembly 21 can be driven to rotate relative to the swinging assembly 24 when the auxiliary assembly 25 moves.

The dexterous hand in the present disclosure is provided with the swinging assembly 24, the joint assembly 21 is rotatably connected to the swinging assembly 24, and the swinging assembly 24 is rotatably connected to the palm structure 10, so that the joint assembly 21 can rotate relative to the swinging assembly 24 so as to enable the joint assembly 21 to bend relative to the palm structure 10, thereby making the joint assembly 21 cooperate with the palm structure 10 for gripping the object. Moreover, since the joint assembly 21 can swing along with the swinging assembly 24 relative to the palm structure 10, the joint assembly 21 can also have a lateral swinging movement in addition to a bending movement, thereby increasing the flexibility of the joint assembly 21. Furthermore, the swinging assembly 24 is elastically connected to the fixing bracket 23, such a connecting manner is such that when the swinging assembly 24 rotates relative to the palm structure 10 under an external force, an elastic force in a direction opposite to a rotation direction of the swinging assembly 24 relative to the palm structure 10 is generated between the swinging assembly 24 and the fixing bracket 23 as a restoring force of the swinging assembly 24, and the restoring force makes the swinging assembly 24 have a tendency to rotate along an opposite direction relative to the palm structure 10 to restore to its original position. When the external force is removed, the restoring force forces the swinging assembly 24 to rotate reversely to restore to its original position, thereby restoring the joint assembly 21 to its original position. In this way, the flexible self-adaptability of the joint assembly 21 can be improved, making the joint assembly 21 move flexibly and restore its original position self-adaptively.

In addition, the auxiliary assembly 25 is further provided in the present disclosure. The auxiliary assembly 25 can transmit a driving force of the first driving assembly 22, so that the joint assembly 21 can rotate relative to the swinging assembly 24, so as to enable the joint assembly 21 to bend relative to the palm structure 10, thereby achieving the cooperation between the joint assembly 21 and the palm structure 10 to grip the object. Furthermore, the auxiliary assembly 25 in the present disclosure is not just configured to transmit the driving force. The auxiliary assembly 25 in the present disclosure is configured to be elastically stretchable. In a case where the first driving assembly 22 loses power, an output end of the first driving assembly 22 remains stationary, and at this moment, when an external force is applied to the joint assembly 21 and the joint assembly 21 is forced to rotate relative to the swinging assembly 24, the auxiliary assembly 25 is compressed under the action of the external force, and the joint assembly 21 can rotate relative to the swinging assembly 24 when the auxiliary assembly 25 is compressed, realizing the effect that the joint assembly 21 can still bend relative to the palm structure 10 even when the first drive assembly 22 is de-energized, ensuring the flexibility of the joint assembly 21. Moreover, when the auxiliary assembly 25 is compressed, the auxiliary assembly 25 has an elastic force for restoring its original state, forcing the auxiliary assembly 25 to have a tendency to return to its original state; and if the external force is removed from the joint assembly 21, the auxiliary assembly 25 can return to its original state through the elastic force. During the process of the auxiliary assembly 25 returning to its original state, the joint assembly 21 is driven to rotate relative to the swinging assembly 24 to restore its original position, thereby increasing the self-adaptive function of the joint assembly 21.

Moreover, the auxiliary assembly 25 in the present disclosure is respectively connected to the joint assembly 21 and the first driving assembly 22 through the universal structure, so that an end of the auxiliary assembly 25 can not only rotate relative to the joint assembly 21 and the first driving assembly 22, but also swing relative to the joint assembly 21 and the first driving assembly 22, to avoid affecting the swinging of the joint assembly 21 along with the swinging assembly 24 relative to the palm structure 10.

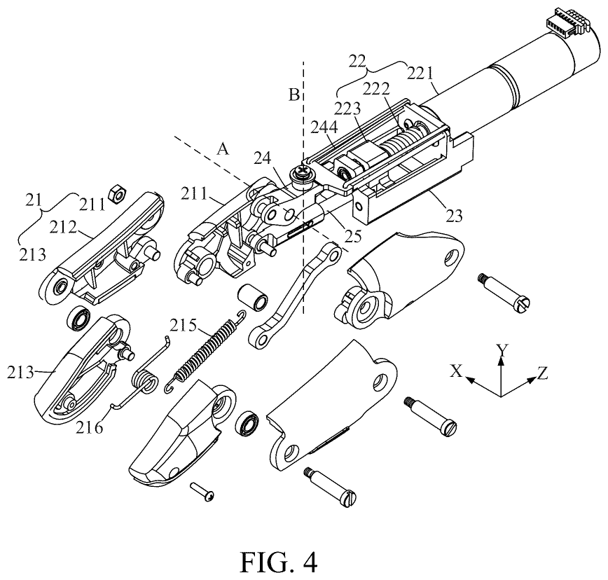

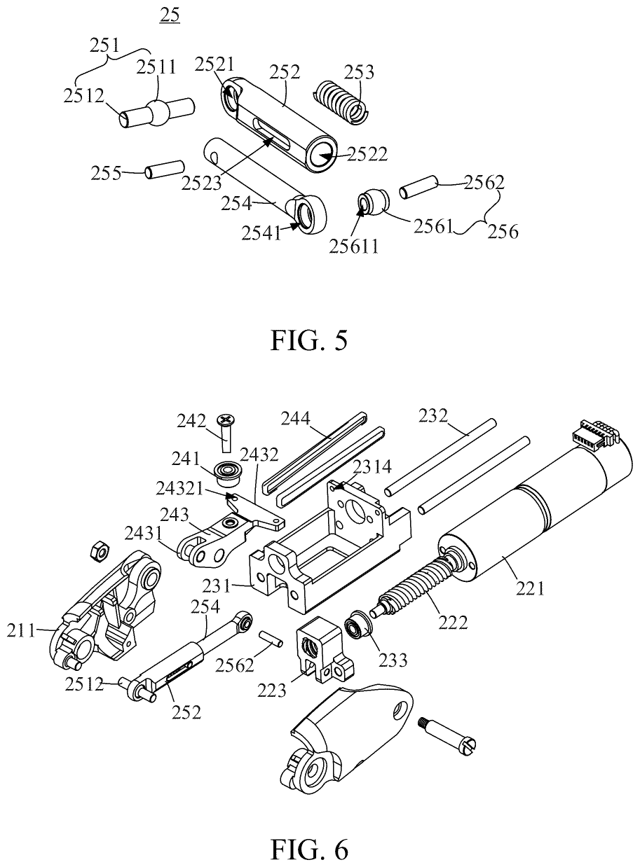

Referring to FIGS. 4 and 5, in some possible implementations, the auxiliary assembly 25 includes a sleeve 252 and a pin rod 254, where the pin rod 254 and the sleeve 252 are slidably connected with each other, so that the pin rod 254 and the sleeve 252 can move towards or away from each other. In addition, a first elastic member 253 is further connected between the sleeve 252 and the pin rod 254. In a free state, the first elastic member 253 does not undergo any deformation, that is, the first elastic member 253 does not generate an elastic force for the pin rod 254 and the sleeve 252. When the pin rod 254 and the sleeve 252 are driven to move relative to each other, the first elastic member 253 generates an elastic force, so that the pin rod 254 and the sleeve 252 have a tendency to return to their original positions.

One end of the sleeve 252 away from the pin rod 254 is connected to a first connecting assembly 251, one end of the pin rod 254 away from the sleeve 252 is connected to a second connecting assembly 256, both the first connecting assembly 251 and the second connecting assembly 256 are universal structures, the sleeve 252 is connected to the joint assembly 21 through the first connecting assembly 251, and the pin rod 254 is connected to the first driving assembly 22 through the second connecting assembly 256.

In some embodiments, the first connecting assembly 251 includes a first ball head 2511 and a connecting rod 2512, where the first ball head 2511 is in a spherical structure, the connecting rod 2512 is provided to protrude from a surface of the first ball head 2511, and the connecting rod 2512 may be rotatably connected to one end of the joint assembly 21 close to the swinging assembly 24. A first connecting hole 2521 is provided at one end of the sleeve 252 away from the pin rod 254, the first ball head 2511 is connected to the first connecting hole 2521, and the first ball head 2511 can perform a circumferential movement within the first connecting hole 2521, matching with the joint assembly 21 to perform the circumferential movement relative to the sleeve 252.

The second connecting assembly 256 includes a second ball head 2561 and a connecting shaft 2562, where the second ball head 2561 is in a spherical structure, a second connecting hole 2541 is provided at one end of the pin rod 254 away from the sleeve 252, the second ball head 2561 is connected to the second connecting hole 2541, and the second ball head 2561 can perform a circumferential movement within the second connecting hole 2541. The connecting shaft 2562 is connected to the second ball head 2561, for example, the connecting shaft 2562 may be provided to protrude from the second ball head 2561, or as in the embodiments of the present disclosure, the second ball head 2561 is provided with an inserting hole 25611, which passes through the second ball head 2561, and the connecting shaft 2562 is inserted into the inserting hole 25611. The connecting shaft 2562 in the present disclosure may be rotatably connected to the output end of the first driving assembly 22, so that an end of the pin rod 254 can perform a circumferential movement relative to the first driving assembly 22.

In some embodiments, the sleeve 252 includes an inserting channel 2522, where the inserting channel 2522 is provided from one end of the sleeve 252 toward the other end of the sleeve 252 along a length direction of the sleeve 252, and the inserting channel 2522 does not penetrate through the other end of the sleeve 252. One end of the pin rod 254 away from the second connecting hole 2541 may be inserted into the inserting channel 2522, and the shape and size of one end of the pin rod 254 configured to be inserted into the inserting channel 2522 are consistent with those of the inserting channel 2522, so that this end of the pin rod 254 may be inserted into and adapted to the inserting channel 2522, thereby achieving the relative sliding between the pin rod 254 and the sleeve 252. But not limited to this, the sleeve 252 and the pin rod 254 may also be slidably connected with each other through the cooperation of a sliding rail and a sliding block, which will not be described in detail in the embodiments of the present disclosure.

It is worth mentioning that, the first elastic member 253 of the present disclosure is a spring, and the first elastic member 253 is provided in the inserting channel 2522 and is located between the bottom of the inserting channel 2522 and the pin rod 254. In a free state, the first elastic member 253 may not undergo any deformation, that is, the first elastic member 253 is neither compressed nor stretched. When the pin rod 254 moves along the inserting channel 2522, the first elastic member 253 may be pressed or stretched, so that the first elastic member 253 generates an elastic force. Specifically, the first elastic member 253 may be pressed when the pin rod 254 and the sleeve 252 move relative to each other, and the first spring 253 may be stretched when the pin rod 254 and the sleeve 252 move away from each other.

In some embodiments, an outer wall of the sleeve 252 is further provided with a limiting groove 2523, the limiting groove 2523 is provided along an extension direction of the inserting channel 2522 and runs through the outer wall of the sleeve 252 and is in communication with the inserting channel 2522. The end of the pin rod 254 inserted into the inserting channel 2522 (the end of the pin rod 254 away from the second connecting hole 2541) is further connected with a limiting pin 255, which is provided to protrude from an end face of the pin rod 254; and when the pin rod 254 is inserted into the inserting channel 2522, the limiting pin 255 is inserted into the limiting groove 2523, so that the limiting pin 255 can move along the limiting groove 2523. The length of the limiting groove 2523 limits a moving range of the limiting pin 255, limiting a moving range of the pin rod 254 relative to the sleeve 252. Therefore, by means of the cooperation of the limiting groove 2523 and the limiting pin 255, the pin rod 254 may be prevented from disengaging from the sleeve 252 when there is movement between the pin rod 254 and the sleeve 252.

For ease of assembly, the limiting pin 255 can be detachably connected to the pin rod 254. For example, a peripheral wall of the pin rod 254 may be provided with a hole structure with a smooth inner wall, the limiting pin 255 may be directly inserted into the hole structure of the peripheral wall of the pin rod 254, and the limiting pin 255 may be tightly matched with the hole structure so as to fix the limiting pin 255 relative to the pin rod 254. Alternatively, the peripheral wall of the pin rod 254 is provided with a threaded hole, an end of the limiting pin 255 is provided with an external thread, and the end of the limiting pin 255 is threadedly connected with the threaded hole, so that the end of the limiting pin 255 may be connected to the peripheral wall of the pin rod 254.

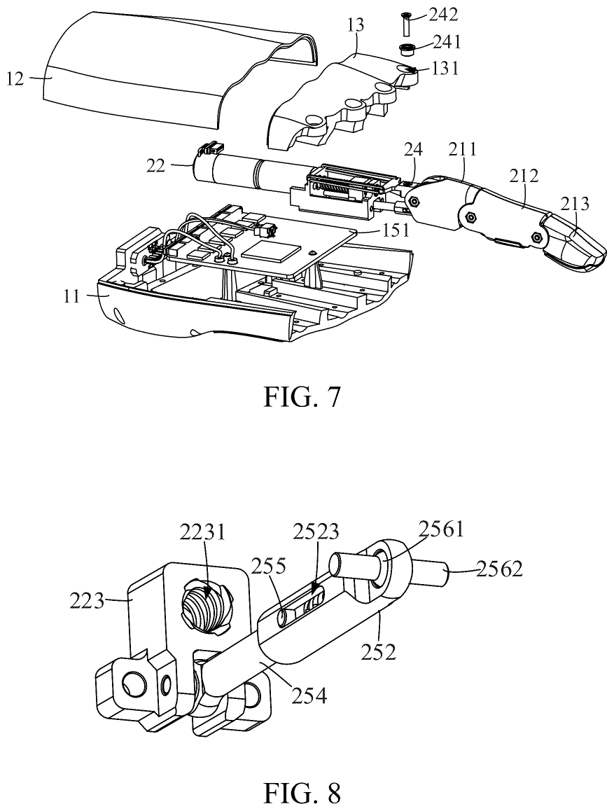

Referring to FIGS. 4 and 6-8, in some possible implementations, the swinging assembly 24 includes a swinging body 243, which is configured to be rotatably connected with the palm structure 10. In this embodiment, the palm structure 10 further includes a fixing base 13, where one end of the fixing base 13 may be connected to the palm center 11, the fixing base 13 is further provided with a plurality of fixing countersunk holes 131, each fixing countersunk hole 131 penetrates through the fixing base 13, the fixing base 13 is correspondingly provided at a position of the swinging assembly 24, and the fixing base 13 is provided with one fixing countersunk hole 131 corresponding to each swinging assembly 24. The swinging assembly 24 further includes a swinging bearing 241, where the swinging bearing 241 may is provided to penetrate into the fixing countersunk hole 131. In the present disclosure, the fixing countersunk hole 131 is a countersunk hole, and a size of the end of the fixing countersunk hole 131 with a larger aperture is adapted to a size of the outer ring of the swinging bearing 241, so that the swinging bearing 241 may be directly accommodated in the end of the fixing countersunk hole 131 with the larger aperture; or, the outer ring of the swinging bearing 241 may also be fixed to an inner wall of the end of the fixing countersunk hole 131 with the larger aperture by means of bonding or the like.

A fixing screw 242 is provided to penetrate through the swinging bearing 241, and the fixing screw 242 passes through the swinging bearing 241 and then passes out of one end of the fixing countersunk hole 131 with a smaller aperture. The swinging body 243 may be provided at an end of the fixing base 13 where the end of the countersink 131 with the larger aperture is located, and an end face of the swinging body 243 facing towards the fixing base 13 is provided with a threaded hole. The threaded hole of the swinging body 243 is provided corresponding to the swinging bearing 241 and the fixing countersunk hole 131 when the swinging body 243 is provided at the fixing base 13. At this moment, the fixing screw 242 can be threadedly connected with the threaded hole after passing through the fixing countersunk hole 131, so that the swinging body 243 and the fixing screw 242 can be connected together. Under the action of the external force, the swinging structure can be driven to rotate relative to the fixing base 13 around a central axis of the swinging bearing 241.

In some embodiments, along a direction perpendicular to a rotation axis of the swinging body 243, one end of the swinging body 243 is provided with a first connecting part 2431, and the other end the swinging body 243 is provided with a second connecting part 2432. The first connecting part 2431 is rotatably connected to the joint assembly 21, and the second connecting part 2432 is elastically connected to the fixing bracket 23, achieving the connection between the swinging body 243, the joint assembly 21 and the fixing bracket 23.

It should be noted that, the second connecting part 3432 and the fixing bracket 23 are connected with each other through an elastic member. For example, the swinging assembly 24 further includes at least one second elastic member 244, two ends of the second elastic member 244 are respectively connected to the second connecting part 2432 and the fixing bracket 23, and the second elastic member 244 is configured to provide for the second connecting part 3432 an elastic force to resist rotation of the swinging body 243.

For ease of description, referring to FIG. 4, a direction indicated by an X axis is a first direction, a direction indicated by a Y axis is a second direction, a direction indicated by a Z axis is a third direction, and the first direction, the second direction, and the third direction are perpendicular to each other. The first direction is parallel to a direction of a rotation axis of the joint assembly 21 when it rotates relative to the swinging assembly 24. In the embodiments of the disclosure, the rotation axis of the joint assembly 21 when it rotates relative to the swinging assembly 24 may be represented by a dashed line A. The second direction is parallel to a direction of a rotation axis of the swinging assembly 24 when it rotates relative to the palm structure 10, and the rotation axis of the swinging assembly 24 when it rotates relative to the palm structure 10 may be represented by a dashed line B. When the swinging assembly 24 does not undergo any swing relative to the palm structure 10, the first connecting part 2431 and the second connecting part 2432 are arranged along the third direction.

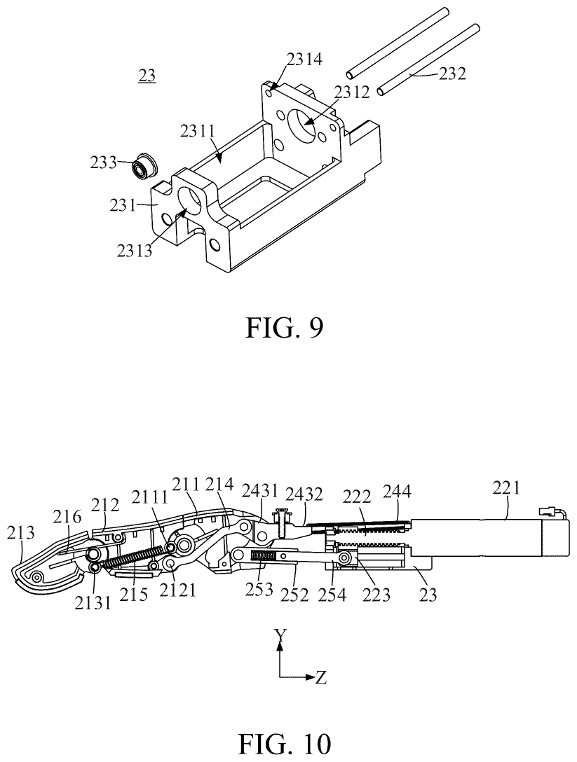

Referring to FIGS. 4, 6 and 9, the second elastic member 244 may be a spring or a structure made of other elastic materials, and in the present disclosure, the second elastic member 244 is an elastic string. One end of the fixing bracket 23 is provided away from the second connection part 2432, and this end of the fixing bracket 23 and the second connection part 2432 are respectively provided with a first mounting hole 2314 and a second mounting hole 24321. The first mounting hole 2314 of the fixing bracket 23 is in a corresponding arrangement to the second mounting hole 24321 of the second connecting part 2432, and the corresponding arrangement means that when the swinging assembly 24 does not swing relative to the palm structure 10, the first mounting hole 2314 of the end of the fixing bracket 23 away from the second connecting part 2432 and the second mounting hole 24321 of the second connecting part 2432 are arranged along the third direction. Two ends of the second elastic member 244 may be respectively connected to the first mounting hole 2314 and the second mounting hole 24321. The second elastic member 244 in the present disclosure is in a closed-loop structure, so that the second elastic member 244 may be directly provided to penetrate through the first mounting hole 2314 and the second mounting hole 24321.

If a plurality of second elastic members 244 are provided, the fixing bracket 23 and the second connecting part 2432 need to be provided with a plurality of first mounting holes 2314 and second mounting holes 24321 respectively. The first mounting holes 2314 of the fixing bracket 23 and the second mounting holes 24321 of the second connecting part 2432 are provided in one-to-one correspondence, and the corresponding first mounting hole 2314 and second mounting hole 24321 are configured to connect with one second elastic member 244. In the embodiments of the present disclosure, a case that two second elastic members 244 are provided is taken as an example for description.

When two second elastic members 244 are provided, the second connecting part 2432 is provided with two second mounting holes 24321, the fixing bracket 23 is provided with two first mounting holes 2314, the two first mounting holes 2314 and the two second mounting holes 24321 are provided in one-to-one correspondence, and the corresponding first mounting hole 2314 and second mounting hole 24321 are configured to connect with one second elastic member 244. The two first mounting holes 2314 and the two second mounting holes 24321 are arranged at intervals along the first direction. In an arrangement direction of the two first mounting holes 2314, the position where the swinging body 243 is connected to the palm structure 10 is located at the center between the two first mounting holes 2314, so that when the swinging body 243 swings along opposite directions relative to the palm structure 10, the restoring forces received are equal.

In some possible implementations, the first driving assembly 22 includes a first driving member 221, a first driving screw rod 222, and a first sliding member 223. The first driving assembly 22 can drive the joint assembly 21 to rotate by means of the cooperation of the first driving member 221, the first driving screw rod 222, and the first sliding member 223. Specifically, in the present disclosure, the first driving member 221 is a driving motor, the first driving member 221 is fixedly connected to the fixing bracket 23, the first driving screw rod 222 is connected to an output end of the first driving member 221, and the first driving member 221 can drive the first driving screw rod 222 to rotate coaxially.

The first sliding member 223 has a threaded hole 2231, and is threadedly connected with the first driving screw rod 222 through the threaded hole 223; and the first sliding member 223 is movably connected to the fixing bracket 23. It should be noted here that the fixing bracket 23 may limit movement of the first sliding member 223, and when the first driving member 221 drives the first driving screw rod 222 to rotate, the first sliding member 223 can rotate relative to the first driving screw rod 222, and the movement of the first sliding member 223 relative to the fixing bracket 23 is configured to limit the first sliding member 223 to only move along a straight line. In addition, it should be noted that, a moving direction of the first sliding member 223 relative to the fixing bracket 23 is parallel to the third direction, so that when the first driving screw rod 222 is rotated, the first sliding member 223 is driven to move along the third direction.

Referring to FIGS. 4, 6 and 9, in some embodiments, the fixing bracket 23 includes a bracket body 231, where the bracket body 231 is further provided with an accommodating groove 2311 along the third direction. Two ends of the bracket body 231 are further provided with a first through-hole 2312 and a second through-hole 2313 along the third direction, the first through-hole 2312 and the second through-hole 2313 are both in communication with the accommodating groove 2311, and the second through-hole 2313 is relatively close to the swinging assembly 24 while the first through-hole 2312 is relatively far away from the swinging assembly 24. The first driving member 221 is fixed to one end of the bracket body 231 provided with the first through-hole 2312, and is located on one side of the bracket body 231 away from the accommodating groove 2311. The first driving member 221 can be detachably connected to the bracket body 231 through a clamping structure, a fastening structure or a screw. The first driving screw rod 222 is provided to penetrate through the first through-hole 2312, the accommodating groove 2311 and the second through-hole 2313 in sequence, so that a middle section of the first driving screw rod 222 is located in the accommodating groove 2311, the first sliding member 223 connected to the first driving screw rod 222 is also located in the accommodating groove 2311, and the first sliding member 223 can move along an extension path of the accommodating groove 2311.

It is worth mentioning that, an adapter 233 is further provided inside the second through-hole 2313, where the adapter 233 is a bearing, an outer ring of the adapter 233 is fixed to an inner wall of the second through-hole 2313, an end of the first driving screw rod 222 can be inserted into an inner ring of the adapter 233, so that a portion of the first driving screw rod 222 located inside the second through-hole 2313 is rotatably connected to the bracket body 231 through the adapter 233.

In the present disclosure, the bracket body 231 is further provided with a plurality of guiding members 232, where each guiding member 232 extend along the third direction, an extension direction of the guiding member 232 is parallel to that of the first driving screw rod 222 and is parallel to the moving direction of the first sliding member 223. The guiding member 232 is in a smooth bar structure, two ends of the guiding member 232 are respectively connected to two ends of the bracket body 231 along the third direction, the guiding member 232 is located inside the accommodating groove 2311, the guiding member 232 is provided to penetrate through the first sliding member 223, and the plurality of guiding members 232 are provided to penetrate through the first sliding member 223, which can restrict the rotation of the first sliding member 223 itself, enabling the first sliding member 223 to move linearly relative to the bracket body 231 along the third direction.

It should be noted that, the pin rod 254 of the auxiliary assembly 25 is connected to the first sliding member 223 through the second connecting assembly 256. Specifically, the connecting shaft 2562 of the second connecting assembly 256 can be rotatably connected to the first sliding member 223. For example, a bearing can be provided at one end of the first sliding member 223, and then the connecting shaft 2562 can be inserted into the inner ring of the bearing of the first sliding member 223, and the connecting shaft 2562 is rotatably connected to the first sliding member 223 through the bearing. When the connecting shaft 2562 is rotatably connected to the first sliding member 223, a rotation axis of the connecting shaft 562 is parallel to the first direction, that is, parallel to a direction of a rotation axis of the joint assembly 21 rotating relative to the swinging assembly 24. In the present disclosure, the position where the first sliding member 223 is configured to be connected to the connecting shaft 2562 is close to the bottom of the accommodating groove 2311. An end hole is provided at one end of the bracket body 231 close to the joint assembly 21 along the third direction, and one end of the pin rod 254 provided with the connecting shaft 2562 can extend into the accommodating groove 2311 through the end hole, so as to be connected to the first sliding member 223 through the connecting shaft 2562.

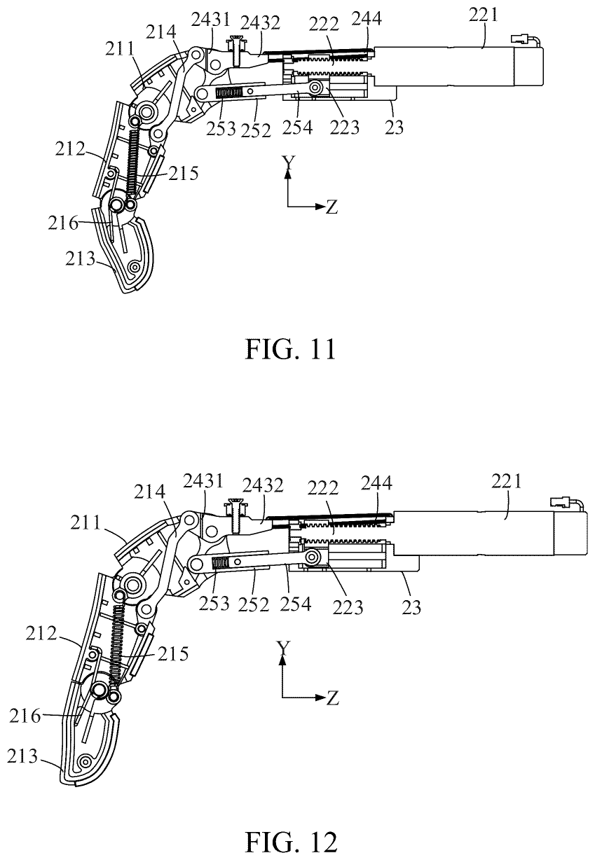

The present disclosure can increase the bending self-adaptability of the joint assembly 21 by providing the auxiliary assembly 25, which can be described with reference to the states of the joint assembly 21 shown in FIGS. 10 to 12. FIG. 10 shows a stretching state of the joint assembly 21, FIG. 11 shows one bending state of the joint assembly 21, and FIG. 12 shows another bending state of the joint assembly 21. When the joint assembly 21 is in the stretching state in FIG. 10, the first sliding member 223 can be driven by the first driving member 221 to translate from left to right relative to the fixing bracket 23, for example, to the position in FIG. 11. During the process of driving the first sliding member 223 to translate, the entire auxiliary assembly 25 can be pulled to move to the right side of the fixing bracket 23, thereby pulling the joint assembly 21 to rotate counterclockwise to the position shown in FIG. 11 based on the perspective shown in FIG. 10.

When the first driving member 221 does not work, that is, when the first sliding member 223 is located at the left end of the fixing bracket 23 and remains stationary, if an external force is applied to the joint assembly 21 in FIG. 10, the joint assembly 21 is forced to rotate counterclockwise. At this moment, the joint assembly 21 can drive the sleeve 252 to move towards the pin rod 254 to press the first elastic member 253 therebetween. The first spring member 253 contracts to give way, so as to allow the joint assembly 21 to rotate counterclockwise to the position shown in FIG. 12. Because the first elastic member 253 is compressed to generate an elastic force, the elastic force of the first elastic member 253 forces the sleeve 252 and the pin rod 254 to move away from each other when the external force on the joint assembly 21 is removed, and when the sleeve 252 moves, the joint assembly 21 is driven to rotate clockwise to its original position, that is, to return to the position shown in FIG. 10. In this way, the bending of the joint assembly 21 can be driven by the first driving member 221, and when the first driving member 221 does not work, the joint assembly 21 can still bend under the action of the external force, and after the external force is removed, the joint assembly 21 restores to its original position, thereby improving the bending self-adaptability of the joint assembly 21.

In some possible implementations, the joint assembly 21 includes a first joint 211, a second joint 212, and a third joint 213 that are provided in sequence, where two ends of the second joint 212 are respectively rotatably connected to the first joint 211 and the third joint 213, and the first joint 211 is rotatably connected to the swinging assembly 24.

It should be noted that, the first joint 211, the second joint 212, and the third joint 213 are each composed of two joint bodies that are set separately, where the two joint bodies may be fixedly connected together through a clamping structure, a fastening structure, or a screw. When the two joint bodies are connected with each other, a chamber is formed between the two joint bodies, so that a chamber is formed inside the first joint 211, the second joint 212, and the third joint 213.

In the present disclosure, the two joint bodies of the first joint 211, the second joint 212 and the third joint 213 are fixedly connected together through the screw. For example, circular holes are provided at both ends of the two joint bodies in a length direction respectively, and the circular holes penetrate through the joint bodies. When the two joint bodies are butted with each other, the circular holes at both ends are correspondingly provided. At this time, the screw may be threaded through the circular holes, so that the screw passes from one end of one joint body through the other end of the other joint body and finally an end of the screw is threadedly connected with a nut, thereby connecting the two joint bodies together.

It is worth mentioning that, the circular hole of the present disclosure may also be a threaded hole, and the screw may be directly connected to the circular hole in a threaded manner.

In some embodiments, in order to further simplify the structure, the connection between the first joint 211 and the swinging assembly 24, as well as the connection between various joints may be directly implemented by the screw connected between joint bodies of each joint.

Specifically, the connection between the first joint 211 and the swinging assembly 24 is taken as an example for description. In the present disclosure, the screw is a shoulder screw having a smooth rod structure in the middle thereof and a screw structure with an external thread at the ends thereof. When the two joint bodies of the first joint 211 are connected together, the first connecting part 2431 of the swinging assembly 24 may be first clamped in the chamber between the two joint bodies. At this moment, circular holes are provided to penetrate through a position where the first joint 211 is connected to the first connecting part 2431 of the swinging assembly 24, and are provided to penetrate through the ends of the two joint bodies of the first joint 211 respectively. A through-hole is also provided at a position of the first connection part 2431 corresponding to the circular hole, and the through-hole penetrates through the first connecting part 2431. Then, the shoulder screw is inserted into the circular hole of one of joint bodies, and is provided to penetrate towards a circular hole of the other joint body. During this process, the shoulder screw passes through the through-hole of the first connecting part 2431 and the circular hole of the other joint body in sequence, and then is threadedly connected with a nut at the other joint body through a threaded portion of the shoulder screw. In this way, the two joint bodies of the first joint 211 can be connected together, and the first joint 211 can also be rotatably connected to the swinging assembly 24 by the shoulder screw.

Similarly, a connecting end is provided at one end of the first joint 211 away from its connection to the swinging assembly 24, and is configured to be rotatably connected to the second joint 212. The screw configured to connect the two joint bodies of the second joint 212 is a shoulder screw. When the two joint bodies of the second joint 212 abut against each other, the connecting end of the first joint 211 can be clamped inside a chamber of the second joint 212. Then, after the shoulder screw passes through one of the joint bodies of the second joint 212, the connecting end of the first joint 211 and the other joint body of the second joint 212 in sequence, and the end of the shoulder screw is threadedly connected with a nut, achieving the connection of the two joint bodies of the second joint 212 and the rotational connection between the second joint 212 and the first joint 211. The connection between the third joint 213 and the second joint 212 is similar to the connection between the second joint 212 and the first joint 211, which will not be described in detail herein.

It should be noted that, when the first joint 211 is connected to the first connecting part 2431 of the swinging assembly 24 through the shoulder screw and when two adjacent joints are connected together through the shoulder screw, a bushing may further be sleeved outside the shoulder screw. The bushing may play a protective role, and may be beneficial to lubrication when the shoulder screw rotates.

It is worth mentioning that, taking the perspective shown in FIG. 10 as an example, a position where the first joint 211 is connected to the second joint 212 and a position where the second joint 212 is connected to the third joint 213 are each provided with a limiting structure, which is configured to limit a bending degree between the joints. The second joint 212 of the present disclosure may rotate clockwise and counterclockwise relative to the first joint 211 about an axis parallel to the first direction, and the third joint 213 may also rotate clockwise and counterclockwise relative to the second joint 212 about the axis parallel to the first direction. When the second joint 212 rotates counterclockwise relative to the first joint 211 and the third joint 213 rotates counterclockwise relative to the second joint 212, the joint assembly 21 rotates towards the palm center 11. When the second joint 212 rotates clockwise relative to the first joint 211 and the third joint 213 rotates clockwise relative to the second joint 212, the joint assembly 21 tends to be straightened, but the joint assembly 21 only needs to be straightened, without bending counterclockwise. Therefore, by providing a limiting structure at a connecting position of the first joint 211 and the second joint 212 and a connecting position of the second joint 212 and the third joint 213, the rotation angle of the second joint 212 relative to the first joint 211 and the rotation angle of the third joint 213 relative to the second joint 212 in the direction away from the palm center 11 can be limited, so that the joint assembly 21 only tends to be straightened, avoiding excessive bending of the joint assembly 21 in the direction away from the palm center 11. The limiting structure may be directly formed by end structures of the first joint 211, the second joint 212, and the third joint 213. When the second joint 212 rotates clockwise relative to the first joint 211 and the third joint 213 rotates clockwise relative to the second joint 212, the limiting structures of the two are configured to limit rotation by abutting against each other.

In some possible implementations, the first joint 211, the second joint 212, and the third joint 213 in the present disclosure also have a linkage effect, that is, when the first joint 211 is driven to rotate relative to the swinging assembly 24, the rotation of the first joint 211 may further drive the second joint 212 and the third joint 213 to rotate.

Specifically, a first connecting rod 214 is further provided in the first joint 211. One end of the first connecting rod 214 is rotatably connected to the swinging assembly 24, and specifically, is rotatably connected to the first connecting part 2431 of the swinging assembly 24, and a rotation axis of the first connecting rod 214 is parallel to that of the first joint 211. A second connecting boss 2121 is provided in the second joint 212; and the other end of the first connecting rod 214 is rotatably connected with the second connecting boss 2121 in the second joint 212.

When the first joint 211 rotates towards the palm center 11 relative to the swinging body 243, the swinging body 243 remains stationary, and a position where the first connecting rod 214 is connected to the first connecting part 2431 is fixed relative to the position of the swinging body 243. However, both the second joint 212 and the third joint 213 rotate along with the first joint 211, and during the rotation of the second joint 212, the first connecting rod 214 will be driven to move. At this moment, the first connecting rod 214 will pull the second joint 212 so as to rotate the second joint 212 relative to the first joint 211, the rotation direction of the second joint 212 facing toward the palm center 11.

It should be noted that, in order to ensure that the second joint 212 may be driven to rotate towards the palm center 11 through the first connecting rod 214 when the first joint 211 rotates towards the palm center 11, it is necessary to set a connecting position where the first connecting rod 214 is connected to the second connecting part 2432 and the second joint 212. For example, taking the perspective in FIG. 10 as an example, the first connecting rod 214 is connected to an end of the first connecting part 2431 away from the second connecting part 2432, and the first connecting part 2431 is further configured to be rotatably connected with the first joint 211. Along the second direction (a direction of the rotation axis of the swinging body 243), a connecting position between the first connecting rod 214 and the first connecting part 2431 is set to be higher than a connecting position between the first connecting part 2431 and the first joint 211 in height, and a connecting position between the first connecting rod 214 and the second joint 212 is close to a rotational connecting position between the second joint 212 and the first joint 211. Moreover, in the second direction, the connecting position between the first connecting rod 214 and the second joint 212 is lower than the rotational connecting position between the second joint 212 and the first joint 211 in a space height. In this way, the connecting position between the first connecting rod 214 and the first connecting part 2431 and the connecting position between the first connecting rod 214 and the second joint 212 may be located on two sides of a connecting line between a rotation center of the first joint 211 and the first connecting part 2431 and a rotation center of the first joint 211 and the second joint 212, respectively. Along the second direction, the connecting position between the first connecting rod 214 and the first connecting part 2431 is higher than the connecting position between the first connecting rod 214 and the second joint 212 in a space height. In this way, when the first joint 211 rotates relative to the swinging body 243 towards the palm center 11, one end of the first connecting rod 214 connected with the first connecting part 2431 may pull the second joint 212 to rotate relative to the first joint 211 towards the palm center 11.

Referring to FIG. 10, in some embodiments, a third elastic member 215 is provided inside the second joint 212, where one end of the third elastic member 215 is connected to the first joint 211, and the other end of the third elastic member 215 is connected to the third joint 213. In the present disclosure, the third elastic member 215 is a spring, a first connecting boss 2111 is further provided to protrude from the first joint 211, a third connecting boss 2131 is provided to protrude from the third joint 213, and two ends of the third elastic member 215 are fixedly connected to the first connecting boss 2111 and the third connecting boss 2131, respectively.

The connecting position between the third elastic member 215 and the first joint 211 is close to the rotation axis of the first joint 211 and the second joint 212. When the joint assembly 21 tends to be straightened, along the second direction, a height of a connecting position between the third elastic member 215 and the first joint 211 is higher than or equal to that of the rotation axis of the second joint 212 and the first joint 211, and a connecting position between the third elastic member 215 and the third joint 213 is lower than the height of the rotation axis of the third joint 213 and the second joint 212. In this way, when the second joint 212 rotates towards the palm center 11, the connecting position between the third elastic member 215 and the first joint 211 can pull the third joint 213, so that the third joint 213 rotates relative to the second joint 212, and the third joint 213 rotates towards the direction of the palm center 11.

It should be noted that, the heights along the second direction mentioned above are described by taking the perspective shown in FIG. 10 as an example.

By providing the first connecting rod 214 and the third elastic member 215, when the first joint 211 rotates towards the palm center 11, the first connecting rod 214 can drive the second joint 212 to rotate relative to the first joint 211, and the rotation of the second joint 212 may further drive the third joint 213 to rotate relative to the second joint 212, thereby achieving the linkage effect, and enabling the entire joint assembly 21 to simulate the bending of a human finger.

In some possible implementations, a torsion spring 216 is further connected at a position of rotation axis between the second joint 212 and the third joint 213, and the rotation axis between the second joint 212 and the third joint 213 passes through a torsion center of the torsion spring 216, and two ends of the torsion spring 216 abut against the second joint 212 and the third joint 213 respectively. Both ends of the torsion spring 216 may directly abut against inner walls of the second joint 212 and the third joint 213, or abutting portions may be respectively provided in the second joint 212 and the third joint 213 and both ends of the torsion spring 216 can abut against the abutting portion of the second joint 212 and the abutting portion of the third joint 213, respectively. The torsion spring 216 is suitable for resisting an elastic force of the third elastic member 215. More specifically, the torsion spring 216 can provide a torsion force for the relative rotation between the second joint 212 and the third joint 213, and the torsion force may force the third joint 213 to have a tendency to rotate away from the palm center 11 relative to the second joint 212. That is, when the joint assembly 21 is in the stretching state as shown in FIG. 10, the torsion force of the torsion spring 216 may make the third joint 213 have a tendency to rotate clockwise relative to the second joint 212. However, at this moment, the clockwise rotation of the third joint 213 relative to the second joint 212 is limited by the limiting structure therebetween, and is also limited by the third elastic member 215.

Referring to FIG. 10 to FIG. 12, when the first joint 211 rotates counterclockwise towards the palm center 11, the second joint 212 and the third joint 213 may be driven to rotate together, the second joint 212 rotates counterclockwise relative to the first joint 211, and the third joint 213 rotates counterclockwise relative to the second joint 212. At this moment, the elastic force of the third elastic member 215 due to stretching is greater than the torsion force of the torsion spring 216, so that the elastic force of the third elastic member 215 can drive the third joint 213 to overcome the torsion force of the torsion spring 216 and rotate, causing the joint assembly 21 to change from the stretching state shown in FIG. 10 to the bending state shown in FIG. 11. When the third joint 213 contacts an object or receives a force opposite to the rotational direction, the third joint 213 may rotate clockwise relative to the second joint 212, causing the joint assembly 21 to change from a bending state shown in FIG. 11 to a bending state shown in FIG. 12. After the external force is removed or the object abutting against the third joint 213 is released, the third joint 213 still rotates counterclockwise relative to the second joint 212 to its original rotational position under the action of the third elastic member 215, and at this moment, the joint assembly 21 changes from the bending state shown in FIG. 12 to the bending state shown in FIG. 11.

Therefore, by providing the torsion spring 216, the torsion spring 216 can apply the torsion force between the third joint 213 and the second joint 212. The torsion force is configured to counteract the elastic force of the third elastic member 215, so that the third joint 213 and the second joint 212 in a free state are in the stretching state. When the second joint 212 rotates and pulls the third elastic member 215, the elastic force of the third elastic member 215 due to stretching is greater than the torsion force of the torsion spring 216, so that the third joint 213 can be driven to rotate relative to the second joint 212, making the third joint 213 have a better self-adaptive function.

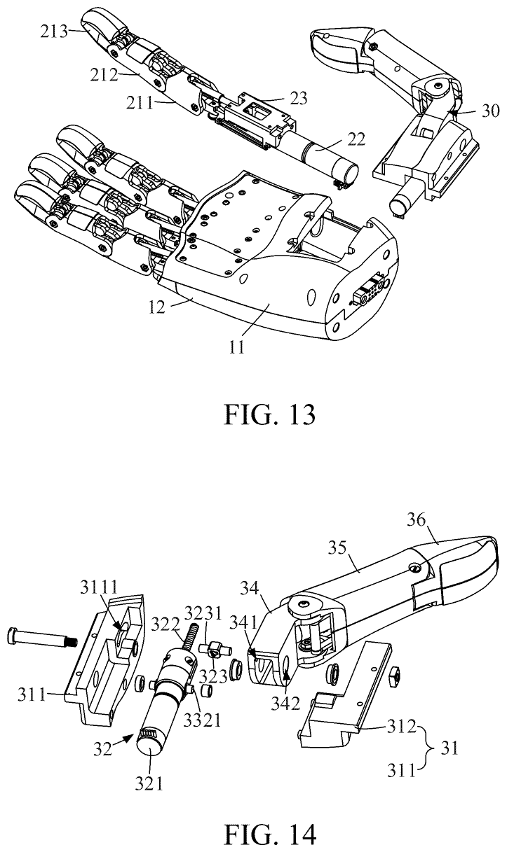

Referring to FIGS. 13 and 14, in some possible implementations, the dexterous hand also includes a thumb structure 30, where the thumb structure 30 is mounted to the palm structure 10 and includes a mounting seat 31, a first knuckle 35, and a second knuckle 36. Two ends of the first knuckle 35 are respectively rotatably connected to the mounting seat 31 and the second knuckle 36, and the mounting seat 31, the first knuckle 35 and the second guide bar 36 are integrated into a whole, which facilitates the modularization arrangement of the thumb structure 30; and the mounting seat 31 may be connected to the palm structure 10, which makes the thumb structure 30 easily assembled to and disassembled from the palm structure 10 separately.

In one embodiment, the thumb structure 30 includes a second driving assembly 32 and a rotating member 34, where the first knuckle 35 is connected to the rotating member 34 and the rotating member 34 is rotatably connected to the mounting seat 31, so that the first knuckle 35 can rotate relative to the mounting seat 31. It should be noted here that a rotation axis between the rotating member 34 and the mounting seat 31 is perpendicular to that between the first knuckle 35 and the second knuckle 36, so as to achieve the rotation of the thumb structure 30 in the two directions, that is, the bending rotation between the knuckles and the flipping movement of the first knuckle 35 and the second knuckle 36 along with the rotating member 34 relative to the mounting seat 31. The second driving assembly 32 in the present disclosure is suitable for driving the rotating member 34 to rotate relative to the mounting seat 31, that is, the second driving assembly 32 is suitable for driving the flipping movement of the first knuckle 35 and the second knuckle 36.

Specifically, in some embodiments, the mounting seat 31 includes a first seat body 311 and a second seat body 312, and the first seat body 311 and the second seat body 312 are detachably connected to each other. For example, the first seat body 311 and the second seat body 312 may be connected to each other through a clamping structure, a fastening structure, or a screw. In the present disclosure, the first seat body 311 and the second seat body 312 are fixedly connected to each other through the screw.

The first seat body 311 and the second seat body 312 are both in a shell structure. When the first seat body 311 is connected to the second seat body 312, an accommodating space is formed between the first seat body 311 and the second seat body 312. A partial structure of the second driving assembly 32 may be located in the accommodating space, and a partial structure of the rotating member 34 may also be located in the accommodating space.

The rotating member 34 and the mounting seat 31 can be connected through a shoulder screw, and the ends of the first seat body 311 and the second seat body 312 for connecting to the rotating member 34 are each provided with circular holes. A first rotating hole 342 is provided to penetrate through one end of the rotating member 34 for connecting to the mounting seat 31, and one end of the rotating member 34 provided with the first rotating hole 342 is provided in the accommodating space, so that the first rotating hole 342 of the rotating member 34 is aligned with the circular holes of the first seat body 311 and the second seat body 312. At this moment, the shoulder screw is penetrated through the circular holes of the first seat body 311 and the second seat body 312 and the first rotating hole 342 of the rotating member 34, and then the end of the threading screw is connected to a nut, which can not only clamp the first seat body 311 and the second seat body 312 tightly so as to make the connection between the first seat body 311 and the second seat body 312 more stable, but also cause the rotating member 34 to be rotatably connected to the mounting seat 31.

It is worth mentioning that, a bearing may be further provided in the first rotating hole 342, and a smooth shaft of the shoulder screw may be provided to penetrate through the bearing. Alternatively, a bushing may be further provided in the first rotating hole 342, and the smooth shaft of the shoulder screw may be provided to penetrate through the bushing, achieving a lubrication function and facilitating reducing the resistance when the rotating member 34 rotates relative to the mounting seat 31.

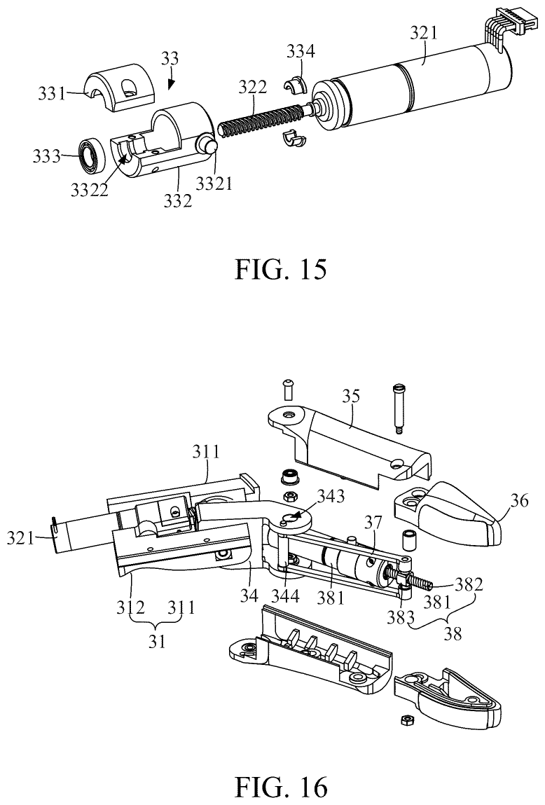

Referring to FIG. 13 to FIG. 15, the thumb structure 30 in the present disclosure further includes a fixing assembly 33. The fixing assembly 33 is rotatably connected to the mounting seat 31, and the second driving assembly 32 includes a second driving member 321, a second driving screw rod 322, and a second sliding member 323. The second driving member 321 is a driving motor and is connected to the fixing assembly 33, so that the second driving member 321 can rotate relative to the mounting seat 31. The second driving screw rod 322 is connected to an output end of the second driving member 321, the second driving member 321 is configured to drive the second driving screw rod 322 to rotate, the second sliding member 323 is provided with a threaded hole 2231, and the second sliding member 323 is threadedly connected to the second driving screw rod 322 through the threaded hole 2231.

The second sliding member 323 is provided with a plurality of connecting protruding blocks 3231, the mounting seat 31 is provided with a sliding groove 3111, the sliding groove 3111 is an arc groove, and a center of the sliding groove 3111 coincides with a rotation axis of the rotating member 34 rotating relative to the mounting seat 31. Specifically, the first seat body 311 may be provided with the sliding groove 3111, and one end of the rotating member 34 facing the sliding groove 3111 is provided with a rotating through-hole 341, and the rotating through-hole 341 is provided corresponding to the sliding groove 3111. When the second sliding member 323 is connected to the second driving screw rod 322, along a direction perpendicular to a length of the second screw rod, at least one pair of connecting protruding blocks 3231 on the second sliding member 323 are located on two opposite sides of the second sliding member 323, and the ends of this pair of connecting protruding blocks 3231 extend away from each other and this pair of connecting protruding blocks 3231 are inserted into the sliding groove 3111 and the rotating through-hole 341, respectively. Certainly, the second sliding member 323 may also be provided with a plurality of pairs of connecting protruding blocks 3231 as described above, and one or more connecting protruding blocks 3231 may be inserted into each of the sliding groove 3111 and the rotating through-hole 341, which is not limited herein.

It is worth mentioning that, when the connecting protruding block 3231 is inserted into the rotating through-hole 341, the connecting protruding block 3231 is rotatably provided relative to the rotating through-hole 341, and a rotation axis between the connecting protruding block 3231 and the rotating through-hole 341 is parallel to a rotation axis between the rotating member 34 and the mounting seat 31.

Based on the above settings, the second driving member 321 can drive the second driving screw rod 322 to rotate; and when the second driving screw rod 322 rotates, the second sliding member 323 rotates relative to the second driving screw rod 322, and the second sliding member 323 is connected to the sliding groove 3111 and the rotating through-hole 341 through the connecting protruding block 3231. Thus, the second sliding member 323 cannot rotate relative to the mounting seat 31, and the second sliding member 323 has a tendency to move along an extension direction of the second driving screw rod 322. In addition, since the sliding groove 3111 is an arc-shaped groove, the sliding groove 3111 may limit a movement path of the second sliding member 323, so that the second sliding member 323 moves along a path of the sliding groove 3111. During the process of the second sliding member 323 moving along the extension path of the sliding groove 3111, the second driving member 321 rotates relative to the mounting seat 31, and the connecting protruding block 3231 connected to the rotating member 34 also moves along the extension path of the sliding groove 3111, thereby driving the rotating member 34 to rotate relative to the mounting seat 31.

In some embodiments, the fixing assembly 33 includes a first fixing member 331 and a second fixing member 332, where the first fixing member 331 and the second fixing member 332 may be connected together through a clamping structure, a fastening structure or a screw. In the present disclosure, the first fixing member 331 and the second fixing member 332 are connected together through the screw. One end of the first fixing member 331 for connecting with the second fixing member 332 is provided with a recessed portion, and one end of the second fixing member 332 for connecting with the first fixing member 331 is provided with a recessed portion. When the first fixing member 331 is connected to the second fixing member 332, the recessed portions therebetween are communicated with each other to form an accommodating space, and an end of the second driving member 321 that is close to and connected with the second driving screw rod 322 can be inserted into the accommodating space. When the first fixing member 331 is connected with the second fixing member 332, the end of the second driving member 321 may be clamped, so that the position of the second driving member 321 is fixed relative to the first fixing member 331 and the second fixing member 332.

The fixing assembly 33 further includes a fixing bearing 333 and a clamping member 334. The second fixing member 332 is provided with a groove 3322 at a position close to a connecting position between the second driving screw rod 322 and the second driving member 321, and the fixing bearing 333 is connected in the groove 3322. By connecting the first fixing member 331 and the second fixing member 332, the fixing bearing 333 can be pressed into the groove 3322. The position where the second driving screw rod 322 is connected to the output end of the second driving member 321 is in a smooth rod structure, the clamping member 334 is sleeved at the smooth rod structure, and then an inner ring of the fixing bearing 333 is sleeved outside the clamping member 334. In this way, the second driving screw rod 322 can be rotatably connected between the first fixing member 331 and the second fixing member 332.

It should be noted that, a connecting protrusion 3321 is further provided to protrude from the second fixing member 332, and the second fixing member 332 can be rotatably connected to the mounting seat 31 through the connecting protrusion 3321. The second fixing member 332 may be provided with a plurality of connecting protrusions 3321, for example, the connecting protrusions 3321 protruding on both sides of the second fixing member 332 facing the first seat body 311 and the second seat body 312 respectively. The second fixing member 332 is rotatably connected to the first seat body 311 and the second seat body 312 respectively through the connecting protrusions 3321 at the two sides. A bearing or a bushing may be sleeved outside the connecting protrusion 3321, and the bearing or the bushing is rotatably connected to the first seat body 311 and the second seat body 312.

Referring to FIGS. 13 and 16, in some possible implementations, the thumb structure 30 further includes a second connecting rod 37 and a third driving assembly 38, where the second connecting rod 37 and the third driving assembly 38 cooperate with each other to drive the first knuckle 35 and the second knuckle 36 to rotate. Specifically, one end of the rotating member 34 away from the first rotating hole 342 is further provided with a second rotating hole 343, and one end of the first knuckle 35 may be rotatably connected to the second rotating hole 343 of the rotating member 34 through the cooperation of the screw and the nut. A rotation axis of the first knuckle 35 and the rotating member 34 is perpendicular to the rotation axis of the rotating member 34 and the mounting seat 31; and a rotation axis of the first knuckle 35 and the rotating member 34 is parallel to a rotation axis of the first knuckle 35 and the second knuckle 36.

One end of the second connecting rod 37 is rotatably connected to the second knuckle 36, and one end of the rotating member 34 away from the first rotating hole 342 is provided with a rotating shaft 344, where the rotating shaft 344 extends in a direction of the rotation axis of the rotating member 34 and the first knuckle 35, and the other end of the second connecting rod 37 is rotatably connected to the rotating shaft 344 on the rotating member 34. The rotation axis of the second connecting rod 37 and the second knuckle 36, and the rotation axis of the second connecting rod 37 and the rotating shaft 344 are each parallel to the rotation axis between the rotating member 34 and the first knuckle 35, and are also parallel to the rotation axis between the first knuckle 35 and the second knuckle 36.

The third driving assembly 38 is rotatably connected to the first knuckle 35, and a partial structure of the third driving assembly 38 is in transmission connection with the second connecting rod 37, so as to drive the first knuckle 35 and the second knuckle 36 to rotate by the second connecting rod 37.

It is worth mentioning that, the way in which the third driving assembly 38 is rotatably connected to the first knuckle 35 is similar to the way in which the second driving assembly 32 is rotatably connected to the mounting seat 31, both using a structure similar to the fixing assembly 33 for connection. A structure similar to the fixing assembly 33 is provided outside the third driving assembly 38 in the present disclosure, and an outer wall of this structure is also provided with a protruding structure similar to the connecting protrusion 3321; and the third driving assembly 38 is rotatably connected to the first knuckle 35 through this structure. For more details, please refer to the description of the fixing assembly 33 and the connection between the fixing assembly 33 and the second driving assembly 32 above, which will not be repeated herein.

The third driving assembly 38 includes a third driving member 381, a third driving screw rod 382, and a third sliding member 383, where the third driving member 381 is a driving motor, the third driving screw rod 382 is connected to an output end of the third driving member 381, and the third driving member 381 is configured to drive the third driving screw rod 382 to rotate. The third sliding member 383 has a threaded hole, the third sliding member 383 is threadedly connected to the third driving screw rod 382 through the threaded hole, and an end of the second connecting rod 37 is rotatably connected to the third sliding member 383. When the second connecting rod 37 is connected to the third sliding member 383, a protruding structure may be provided to protrude from an end of the second connecting rod 37 and then the protruding structure is then inserted into an outer wall of the third sliding member 383; or a protruding structure is provided to protrude from a peripheral wall of the third sliding member 383 along a direction perpendicular to a rotation axis of the third driving screw rod 382 and the protruding structure is inserted into an end of the second connecting rod 37, so as to achieve the rotational connection between the second connecting rod 37 and the third sliding member 383. It should be noted that, a position where the second connecting rod 37 is connected to the third sliding member 383 is also rotatably connected to the second knuckle 36. Specifically, a protruding block may be provided at the position of the second connecting rod 37 for connecting to the third sliding member 383, the second knuckle 36 is provided with a hole structure in close proximity to its rotational connection to the first knuckle 35, and the second connecting rod 37 can be rotatably connected to the second knuckle 36 by inserting the protruding block into the hole structure.

It should be noted that, assuming that a connecting line between a connecting center of the first knuckle 35 and the second knuckle 36 and a connecting center of the first knuckle 35 and the rotating member 34 is L, and a connecting line between a connecting center of the second connecting rod 37 and the second knuckle 36 and a connecting center of the second connecting rod 37 and the rotating member 34 is H, then intermediate parts between the connecting line L and the connecting line H are intersected, forming an included angle therebetween, and the included angle is an acute angle. That is to say, the connecting position of the second connecting rod 37 and the second knuckle 36 as well as the connecting position of the second connecting rod 37 and the rotating member 34 are respectively located on both sides of the connecting line L, and the connecting center of the second connecting rod 37 and the second knuckle 36 is located on a side which is relatively far away from an end face of the second knuckle 36 for contact with the object, while the connecting center of the second connecting rod 37 and the rotating member 34 is located on a side which is relatively close to an end face of the first knuckle 35 for contact with the object.

In this way, when the third driving assembly 38 drives the third driving screw rod 382 to rotate, because the third sliding member 383 is rotatably connected to the second knuckle 36 through the second connecting rod 37, the third sliding member 383 moves along a length direction of the third driving screw rod 382, and at this moment, the third sliding member 383 pushes the second knuckle 36 to rotate relative to the first knuckle 35. Meanwhile, the third driving member 381 rotates relative to the first knuckle 35, the second connecting rod 37 also rotates relative to the rotating member 34, a connecting rod structure is formed among the rotating member 34, the second connecting rod 37, the second knuckle 36, the third driving member 381, and the first knuckle 35, and the rotation of the second connecting rod 37 enables the first knuckle 35 to also rotate relative to the rotating member 34, thereby enabling the first knuckle 35 and the second knuckle 36 to rotate at the same time.

In some embodiments, a plurality of second connecting rods 37 may also be provided. For example, two second connecting rods 37 are provided in the present disclosure. The two second connecting rods 37 are provided at intervals along a direction of the rotation axis of the rotational connection between the rotating member 34 and the first knuckle 35. The third driving member 381 is located between two second connecting rods 37, and one end of each of the two second connecting rods 37 is rotatably connected to the rotating member 34, and the other end of each of the two second connecting rods 37 is rotatably connected to the third sliding member 383. The two second connecting rods 37 are arranged in parallel. By providing the two second connecting rods 37, a uniform driving force can be applied to the second knuckle 36.

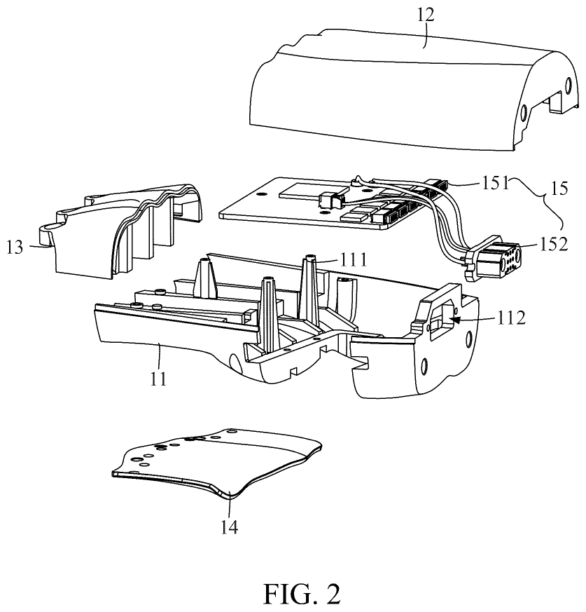

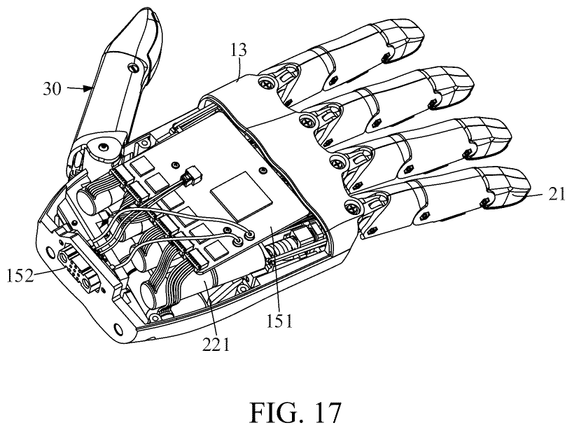

Referring to FIGS. 2 and 17, in some embodiments, the present disclosure has the first driving member 221, the second driving member 321, and the third driving member 381. In order to control the operation of the three driving members, the palm structure 10 further includes a control assembly 15, where the control assembly 15 includes a control board 151 and a communication interface 152 provided on the control board 151. The first driving member 221, the second driving member 321, and the third driving member 381 are each provided with a communication connector for connecting with the control board 151. By connecting the communication connector to the control board 151, the first driving member 221, the second driving member 321 and the third driving member 381 may be in connection with the control board 151 by means of signal, and the control board 151 is further connected with external communication devices through the communication interface 152.

The control assembly 15 in the present disclosure is mounted on the palm center 11 or the palm back 12. For example, in the embodiments of the present disclosure, a fixing member 111 is provided to protrude from the palm center 11 and is provided with a threaded hole; a screw may be provided to penetrate through the control board 151; and the screw can be threadedly connected into the threaded hole of the fixing member 111, so that the control board 151 is fixedly connected to the palm center 11.

When the control board 151 is connected to the palm center 11, the control board 151 is located in the accommodating space between the palm center 11 and the palm back 12. The palm center 11 and the palm back 12 are further provided with a mounting port 112 at their end away from the joint assembly 21. The communication interface 152 on the control board 151 can be inserted into the mounting port 112 to protrude out of the palm structure 10, facilitating the connection with the outside.

In another aspect, the embodiments of the present disclosure further provide a humanoid robot, including a robot body and the dexterous hand described above.

After considering the specification and practicing the contents disclosed herein, those skilled in the art will easily conceive of other embodiments of the disclosure. The present disclosure is intended to cover any variations, uses, or adaptive changes of the present disclosure, and these variations, uses, or adaptive changes follow the general principles of the present disclosure and include common general knowledge or customary technical means in the art that are not disclosed the present disclosure.

It should be understood that the present disclosure is not limited to the precise structures described above and shown in the accompanying drawings, and various modifications and changes may be made without departing from the scope thereof.

1. A dexterous hand, comprising:
a palm structure;
a gripping finger structure, wherein the gripping finger structure comprises a joint assembly, a first driving assembly, a swinging assembly, a fixing bracket and an auxiliary assembly, and the fixing bracket is connected to the palm structure;
the swinging assembly is rotatably connected to the palm structure, the swinging assembly is elastically connected to the fixing bracket, the joint assembly is rotatably connected to the swinging assembly, and a rotation axis of the swinging assembly is perpendicular to a rotation axis of the joint assembly; and
the auxiliary assembly is configured to be elastically stretchable, and along an expansion and contraction direction of the auxiliary assembly, one end of the auxiliary assembly is connected to the joint assembly through a universal structure, the other end of the auxiliary assembly is connected to the first driving assembly through the universal structure, the first driving assembly is connected to the fixing bracket, and the first driving assembly is adapted to drive the joint assembly to rotate relative to the swinging assembly by driving the auxiliary assembly to move.

2. The dexterous hand according to claim 1, wherein the auxiliary assembly comprises a sleeve and a pin rod, the pin rod is slidably connected to the sleeve, a first elastic member is connected between the sleeve and the pin rod, one end of the sleeve away from the pin rod is connected with a first connecting assembly, one end of the pin rod away from the sleeve is connected with a second connecting assembly, and the first connecting assembly and the second connecting assembly are each a universal structure.

3. The dexterous hand according to claim 2, wherein the first connecting assembly comprises a first ball head and a connecting rod, the connecting rod is provided to protrude from the first ball head, the connecting rod is adapted to be rotatably connected to the joint assembly, a first connecting hole is provided at the one end of the sleeve away from the pin rod, and the first ball head is connected to the first connecting hole; and
the second connecting assembly comprises a second ball head and a connecting shaft, a second connecting hole is provided at the one end of the pin rod away from the sleeve, the second ball head is connected to the second connecting hole, the connecting shaft is connected to the second ball head, and the connecting shaft is adapted to be rotatably connected to the first driving assembly.

4. The dexterous hand according to claim 3, wherein an outer wall of the sleeve is further provided with a limiting groove, the limiting groove is provided along a sliding direction of the pin rod relative to the sleeve, a limiting pin is further connected to the pin rod, and the limiting pin is inserted into the limiting groove.

5. The dexterous hand according to claim 1, wherein along a direction perpendicular to a rotation axis of the swinging assembly, one end of the swinging assembly is provided with a first connecting part, and the other end of the swinging assembly is provided with a second connecting part; and the first connecting part is rotatably connected to the joint assembly, and the second connecting part is elastically connected to the fixing bracket.

6. The dexterous hand according to claim 2, wherein along a direction perpendicular to a rotation axis of the swinging assembly, one end of the swinging assembly is provided with a first connecting part, and the other end of the swinging assembly is provided with a second connecting part; and the first connecting part is rotatably connected to the joint assembly, and the second connecting part is elastically connected to the fixing bracket.

7. The dexterous hand according to claim 3, wherein along a direction perpendicular to a rotation axis of the swinging assembly, one end of the swinging assembly is provided with a first connecting part, and the other end of the swinging assembly is provided with a second connecting part; and the first connecting part is rotatably connected to the joint assembly, and the second connecting part is elastically connected to the fixing bracket.

8. The dexterous hand according to claim 4, wherein along a direction perpendicular to a rotation axis of the swinging assembly, one end of the swinging assembly is provided with a first connecting part, and the other end of the swinging assembly is provided with a second connecting part; and the first connecting part is rotatably connected to the joint assembly, and the second connecting part is elastically connected to the fixing bracket.

9. The dexterous hand according to claim 1, wherein the first driving assembly comprises a first driving member, a first driving screw rod and a first sliding member; the first driving member is connected to the fixing bracket, and the first driving screw rod is connected to an output end of the first driving member; the first sliding member has a threaded hole, the first sliding member is threadedly connected to the first driving screw rod through the threaded hole, the first sliding member is movably connected to the fixing bracket, and one end of the auxiliary assembly is connected to the first sliding member.

10. The dexterous hand according to claim 2, wherein the first driving assembly comprises a first driving member, a first driving screw rod and a first sliding member; the first driving member is connected to the fixing bracket, and the first driving screw rod is connected to an output end of the first driving member; the first sliding member has a threaded hole, the first sliding member is threadedly connected to the first driving screw rod through the threaded hole, the first sliding member is movably connected to the fixing bracket, and one end of the auxiliary assembly is connected to the first sliding member.

11. The dexterous hand according to claim 3, wherein the first driving assembly comprises a first driving member, a first driving screw rod and a first sliding member; the first driving member is connected to the fixing bracket, and the first driving screw rod is connected to an output end of the first driving member; the first sliding member has a threaded hole, the first sliding member is threadedly connected to the first driving screw rod through the threaded hole, the first sliding member is movably connected to the fixing bracket, and one end of the auxiliary assembly is connected to the first sliding member.

12. The dexterous hand according to claim 4, wherein the first driving assembly comprises a first driving member, a first driving screw rod and a first sliding member; the first driving member is connected to the fixing bracket, and the first driving screw rod is connected to an output end of the first driving member; the first sliding member has a threaded hole, the first sliding member is threadedly connected to the first driving screw rod through the threaded hole, the first sliding member is movably connected to the fixing bracket, and one end of the auxiliary assembly is connected to the first sliding member.

13. The dexterous hand according to claim 1, wherein the joint assembly comprises a first joint, a second joint and a third joint which are provided in sequence; two ends of the second joint are respectively rotatably connected to the first joint and the second joint; the first joint is rotatably connected to the swinging assembly, and a first connecting rod is further provided inside the first joint; one end of the first connecting rod is rotatably connected to the swinging assembly, and the other end of the first connecting rod is rotatably connected to the second joint.

14. The dexterous hand according to claim 2, wherein the joint assembly comprises a first joint, a second joint and a third joint which are provided in sequence; two ends of the second joint are respectively rotatably connected to the first joint and the third joint; the first joint is rotatably connected to the swinging assembly, and a first connecting rod is further provided inside the first joint; one end of the first connecting rod is rotatably connected to the swinging assembly, and the other end of the first connecting rod is rotatably connected to the second joint.

15. The dexterous hand according to claim 13, wherein a third elastic member is provided inside the second joint, one end of the third elastic member is connected to the first joint, and the other end of the third elastic member is connected to the third joint.

16. The dexterous hand according to claim 14, wherein a third elastic member is provided inside the second joint, one end of the third elastic member is connected to the first joint, and the other end of the third elastic member is connected to the third joint.

17. The dexterous hand according to claim 15, wherein a rotation axis of the second joint and the third joint is further connected to a torsion spring, two ends of the torsion spring are respectively abutted against the second joint and the third joint, and the torsion spring is adapted to resist an elastic force of the third elastic member.

18. The dexterous hand according to claim 16, wherein a rotation axis of the second joint and the third joint is further connected to a torsion spring, two ends of the torsion spring are respectively abutted against the second joint and the third joint, and the torsion spring is adapted to resist an elastic force of the third elastic member.

19. A humanoid robot, comprising a robot body and the dexterous hand according to claim 1.
